(19) United States
(12) Patent Application Publication
(10) Pub. No.: US 2010/0219156 A1
(43) Pub. Date: Sep. 2, 2010

(54) THREE-DIMENSIONAL MAGNETIC STRUCTURE FOR MICROASSEMBLY

(75) Inventors: Roger Lee Hipwell, JR., Eden Prairie, MN (US); Nurul Amin, Woodbury, MN (US); Jun Zheng, Edina, MN (US); Ming Sun, Eden Prairie, MN (US); Haiwen Xi, Prior Lake, MN (US)

Correspondence Address: CAMPBELL NELSON WHIPPS, LLC, HISTORIC HAMM BUILDING, 408 SAINT PETER STREET, SUITE 240, ST. PAUL, MN, 55102, US

(73) Assignee: SEAGATE TECHNOLOGY LLC, Scotts Valley, CA (US)

(21) Appl. No.: 12/396,074

(22) Filed: Mar. 2, 2009

(51) Int. Cl. B44C 1/22; B05D 5/12

(52) U.S. Cl. 216/22; 427/129

(57) ABSTRACT

Micro structures and methods for creating complex, 3-dimensional magnetic micro components and their application for batch-level microassembly. Included is a method for making complex, 3-dimensional magnetic structures by depositing a first photoimageable magnet/polymer material on a substrate and patterning to form at least one first active magnetic area and at least one first sacrificial area, then depositing a second photoimageable magnet/polymer material and patterning to form at least one second active magnetic area and at least one second sacrificial area, and then removing the first sacrificial area and the second sacrificial area. Also included is a micro structure self assembly method, the method including providing a substrate having at least one magnetic receptor site, and engaging a 3-dimensional magnetic micro structure having a magnetic micro component with the substrate by aligning the magnetic micro component with the magnetic receptor site.

### BACKGROUND

Miniature (e.g., nanoscale) components are the basis for micro electro mechanical systems (MEMS). Assembly of complicated microfabricated components has been a key need for many MEMS sensors and devices. Precision serial assembly of components by micromanipulators is extremely slow and expensive for low-cost applications. Often, applications such as microphotonics (e.g., assembly of micromirrors), geometrically sensitive assembly (e.g., integration of multiple-axis acceleration sensors) and micro-robotics present cost pressures that limit design and process options. Current methods for batch assembly include simple shape fitting, but are limited in their ability to specific complex, 3D orientations.

In addition to the assembly of microcomponents, electromagnetic MEMS and other microfabricated structures often require integration of strong electromagnetic elements. In particular, permanent-magnet structures are often used in electromagnetic actuation or sensor circuits. While magnetically biased permanent-magnet films can be electroplated, the thickness is often limited due to seedlayer grain dependence and stress considerations. Bulk magnets can be assembled onto a device or wafer, but require the use of additional, non-batch-fabrication methods. In addition, complex geometries are often desired that cannot be met by conventional bulk magnet machining.

### BRIEF SUMMARY

The present disclosure relates to micro structures and methods for creating complex, microfabricated magnetic micro components and their application for batch-level microassembly. The methods include the use of photoimageable polymers with magnetic particles therein to obtain complicated, 3-dimensional micro components and micro structures. In addition, complex 3-dimensional micro structures can be incorporated into the microassembly of MEMS devices (e.g., sensors, actuators, speakers, etc.) and into complex electromagnetic applications.

In one particular embodiment, this disclosure provides a micro structure self assembly method, the method comprising providing a substrate having at least one magnetic receptor site, and engaging a 3-dimensional magnetic micro structure having a magnetic micro component with the substrate by aligning the magnetic micro component with the magnetic receptor site.

In another particular embodiment, this disclosure provides a method of making a 3-dimensional magnetic micro structure, the method comprising depositing a first photoimageable magnet/polymer material on a substrate and patterning the first photoimageable magnet/polymer material to form at least the first active magnetic area and at least one first sacrificial area. Then, the method includes depositing a second photoimageable magnet/polymer material on the at least one first active magnetic area and at least one first sacrificial area and patterning that second photoimageable magnet/polymer material to form at least one second active magnetic area and at least one second sacrificial area. The first sacrificial area and the second sacrificial area are removed.

These and various other features and advantages will be apparent from a reading of the following detailed description.

### BRIEF DESCRIPTION OF THE DRAWINGS

The disclosure may be more completely understood in consideration of the following detailed description of various embodiments of the disclosure in connection with the accompanying drawings, in which:

FIGS. 1A-1C are schematic step-wise diagrams of a method of making a 3-dimensional magnetic micro structure;

FIGS. 2A-2G are schematic step-wise diagrams of another method of making a 3-dimensional magnetic micro structure;

FIGS. 3A-3J are schematic step-wise diagrams of yet another method of making a 3-dimensional magnetic micro structure;

FIG. 4 is a schematic diagram of a 3-dimensional magnetic micro structure made by the method of FIGS. 3A-3J;

FIGS. 5A-5F are schematic step-wise diagrams of another method of making a 3-dimensional magnetic micro structure;

FIGS. 6A-6D are schematic step-wise diagrams of a method of making components of a 3-dimensional magnetic structure; and

FIGS. 7A-7D are schematic step-wise diagrams of a method of assembling 3-dimensional magnetic micro structures.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

In the following description, reference is made to the accompanying set of drawings that form a part hereof and in which are shown by way of illustration several specific embodiments. It is to be understood that other embodiments are contemplated and may be made without departing from the scope or spirit of the present disclosure. The following detailed description, therefore, is not to be taken in a limiting sense. Any definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

In some embodiments, the present disclosure relates to the use of permanent-magnet particles or powders in a polymer to form 3-dimensional magnetic micro components and micro structures. The disclosure describes various methods of forming 3-dimensional magnetic micro components, including photopatternability of the magnet-containing polymer, the use of multiple coating and patterning layers, conformal coating methods, and complex damascene 3-dimensional mold structures. The magnetic micro components and micro structures formed by any of these methods can be used in magnetic applications such as micro assembly. While the present disclosure is not so limited, an appreciation of various aspects of the disclosure will be gained through a discussion of the examples provided below.

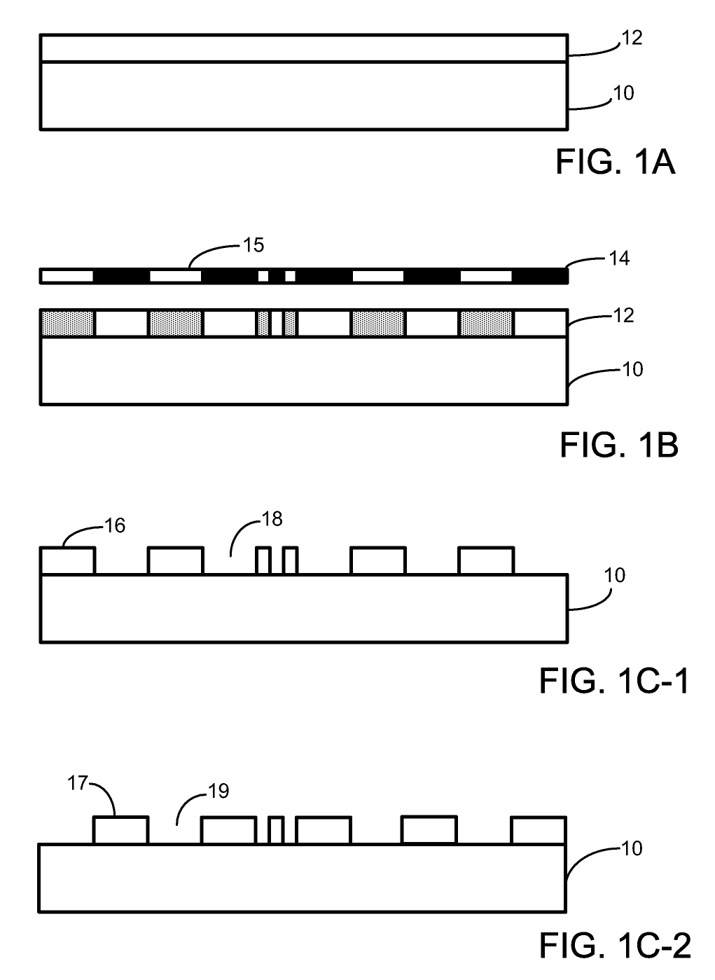

A first embodiment of this disclosure involves using photoimageable coatings of permanent-magnets to form micro scale patterns. By utilizing a photosensitive polymer(s) (e.g., a photoresist, epoxy, etc.), a magnet-containing polymer can be formed into a photo-defined configuration. A projection stepper or contact mask aligner is used to expose the desired pattern into the magnet/polymer layer. In a negative tone resist, the exposed magnet/polymer film undergoes a chemical reaction that serves to crosslink the polymer and remain in place during a subsequent chemical developing step. In a positive resist, exposed areas undergo a chemical reaction that allows the exposed magnet/polymer film to develop away in exposed areas. FIGS. 1A-1C illustrate an example of such a photolithographically defined permanent-magnet (PM) micro structure.

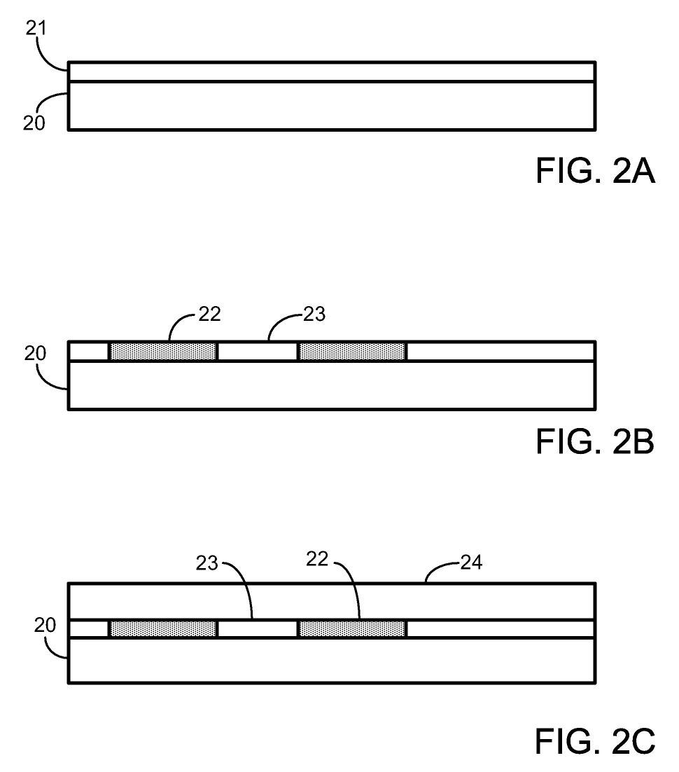

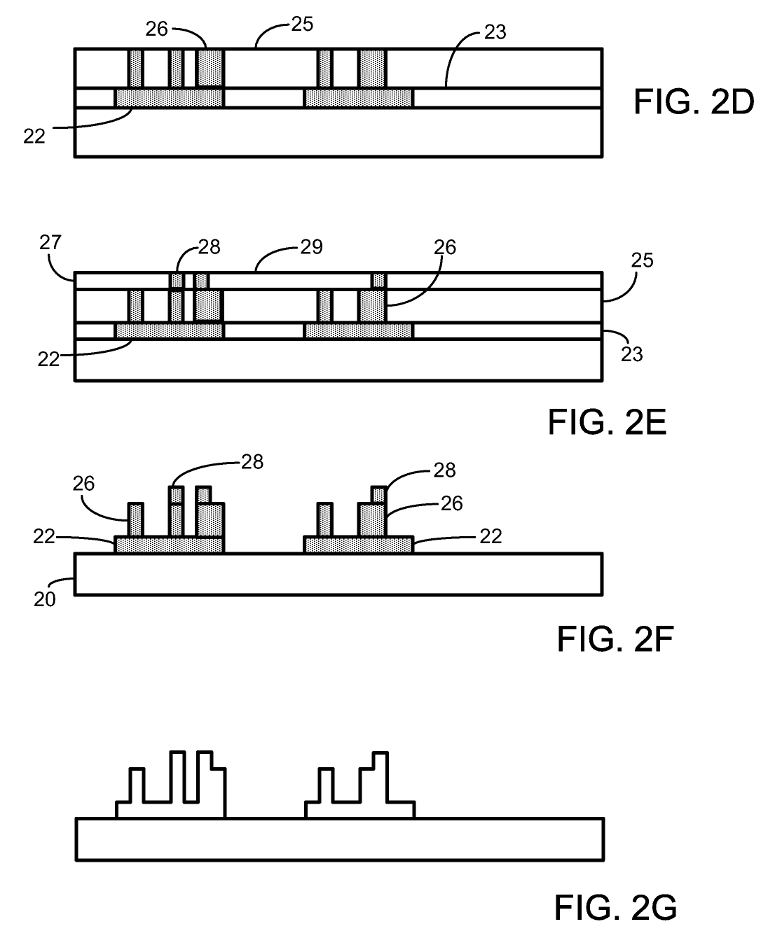

FIG. 1A illustrates a base substrate 10 having a coating or layer of photosensitive magnet/polymer material 12. A mask 14 having a plurality of apertures 15 forming a desired pattern is positioned in close proximity to or in the exposure path of magnet/polymer layer 12 in FIG. 1B. The desired pattern is exposed into magnet/polymer layer 12 through apertures 15. FIG. 1C-1 illustrates the resulting structure from a “negative-resist”, where magnet/polymer layer 12 in exposed areas 16 remains and the unexposed areas 18 of magnet/polymer layer 12 were removed. FIG. 1C-2 illustrates the resulting structure from a “positive resist”, where the unexposed areas 17 of magnet/polymer layer 12 remain and the exposed areas 19 of magnet/polymer layer 12 were removed.

One feature of this process is that by using a high-aspect ratio magnet/polymer layer, high-aspect ratio magnetic micro components can be patterned as desired. In addition, when using a negative-tone resist, a multi-exposure, multi-level structure can be created as shown in the method of FIGS. 2A-2G below. Such a method allows for a complex set of geometry that could not be achieved by conventional bulk machining methods and may be difficult (if not impossible) with electroplating.

In FIG. 2A, a base substrate 20 having a coating or layer of photosensitive magnet/polymer material 21 thereon is shown. A desired pattern is exposed into magnet/polymer layer 21 in FIG. 2B, resulting in active magnetic material 22 (e.g., exposed areas if from a negative-resist process) and sacrificial areas 23 (e.g., unexposed areas if from a negative-resist process). Areas 23, in this particular sequence of steps in FIGS. 2A-2G, will eventually be removed. A second, subsequent magnet/polymer layer 24 is applied in FIG. 2C and imparted with a desired pattern in FIG. 2D in a manner similar to the first pattern in FIG. 2B to form second sacrificial areas 25 and second active magnetic material 26. In FIG. 2E, a third magnet/polymer layer 27 is applied and patterned to provide third active magnetic material 28 and third sacrificial areas 29. The sacrificial areas 23, 25, 29 are removed in FIG. 2F, leaving on substrate 20 the 3-dimensional magnetic micro components formed by active magnetic material 22, 26, 28, shown in FIG. 2G.

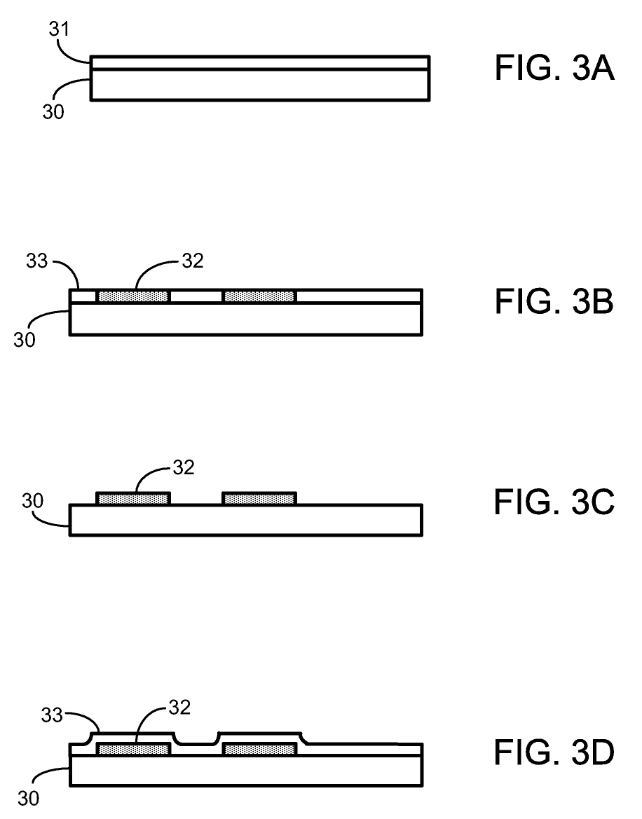

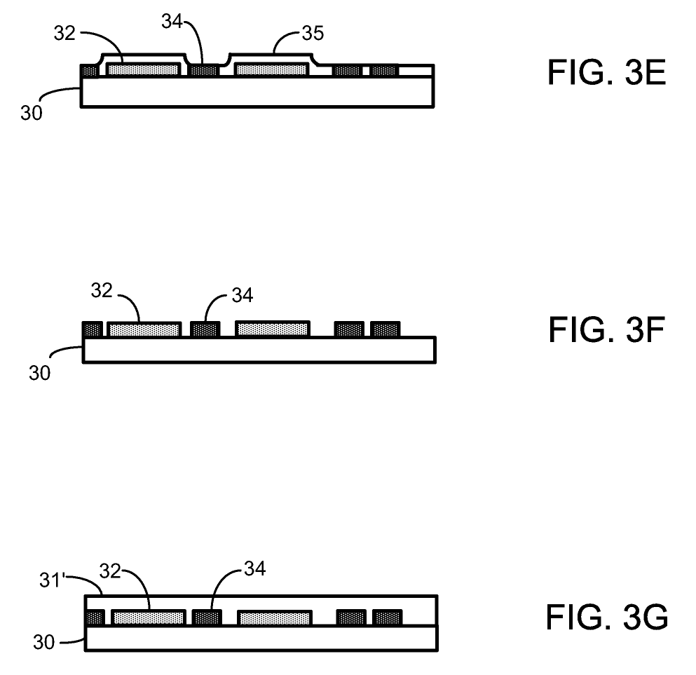

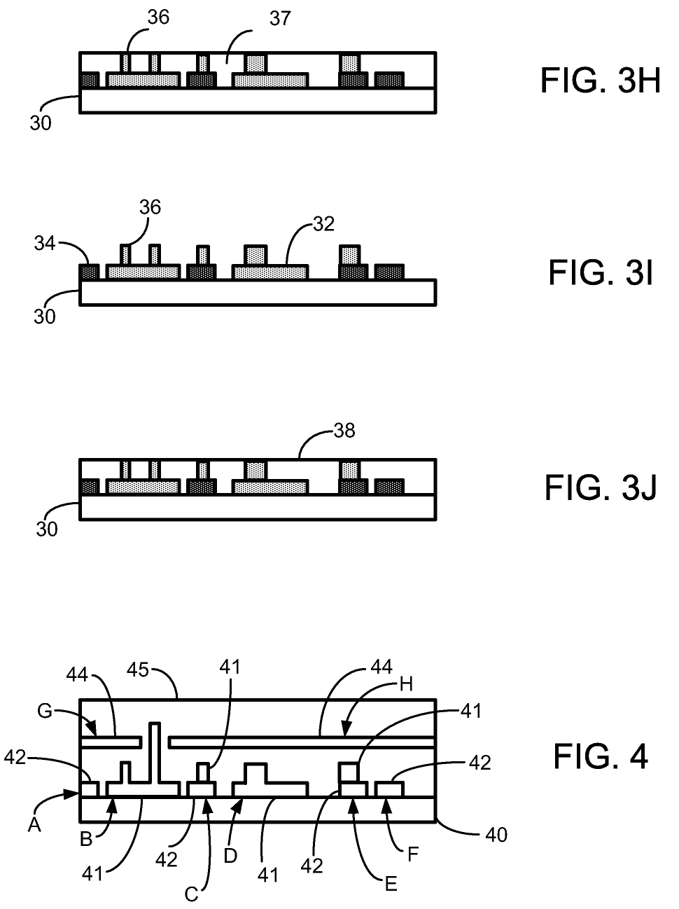

In addition to being able to create complex, multilevel 3-dimensional polymer magnet shapes by photoimaging coatings of magnetic material (e.g., permanent-magnetic material), as illustrated in the methods of FIGS. 1A-1C and FIGS. 2A-2G, it is possible to combine magnet/polymer layers or patterns with non-magnetic layers or shapes (e.g., either polymeric or non-polymeric). Similarly, it is possible to combine different magnetic films (e.g., hard-magnetic films, soft-magnetic films, polymer magnets, plated magnets, etc.) with magnet/polymer layers. Such a method is illustrated in FIGS. 3A-3J.

Base substrate 30 in FIG. 3A has a coating or layer of photosensitive magnet/polymer material 31 thereon. A desired pattern is exposed into magnet/polymer layer 31 in FIG. 3B, resulting in active magnetic material 32 (e.g., exposed areas if from a negative-resist process) and sacrificial areas 33 (e.g., unexposed areas if from a negative-resist process). Areas 33 are removed in FIG. 3C. A second layer 33, different from magnet/polymer layer 31, is applied over base substrate 30 and active magnetic material 32 in FIG. 3D and imparted with a desired pattern in FIG. 3E to form second active material 34 and second sacrificial areas 35. Sacrificial areas 35 are removed in FIG. 3F. In FIG. 3G, a third layer 31′, e.g., the same as magnet/polymer layer 31, is applied over active magnetic material 32 and second active material 34 and imparted with a desired pattern in FIG. 3H, forming active magnetic material 36 and sacrificial areas 37. Sacrificial areas 37 are removed in FIG. 3I, leaving active magnetic material 32, 36 and second active material 34 on substrate 30. The resulting micro components are encased with non-magnetic material 38 in FIG. 3J and the surface is planarized.

An example of a micro structure that can be fabricated using the method shown in FIGS. 3A-3J, with additional steps, is illustrated in FIG. 4. The magnetic micro structure of FIG. 4 has a base substrate 40 on which are various 3-dimensional components, labeled as components A, B, C, D, E, F, G and H. These components are formed from active magnetic material 41, first material 42 and second material 44, and are all encased with non-magnetic material 45. The various components have differing shapes, sizes, and composition. Component A is a single level component on substrate 40 formed of first material 42. Component B is a multi-level homogeneous component on substrate 40 all formed of active magnetic material 41. Component C is a multi-level heterogeneous component on substrate 40, with the lower level formed of first material 42 and the upper level formed of active magnetic material 41. Component D is a multi-level homogeneous component on substrate 40 all formed of active magnetic material 41. Component E is a multi-level heterogeneous component on substrate 40, with the lower level formed of first material 42 and the upper level formed of active magnetic material 41. Component F is a single level component on substrate 40 formed of first material 42. Components G and H are single level components distanced or spaced from substrate 40, components G and H being planar with each other, and both formed of second material 44.

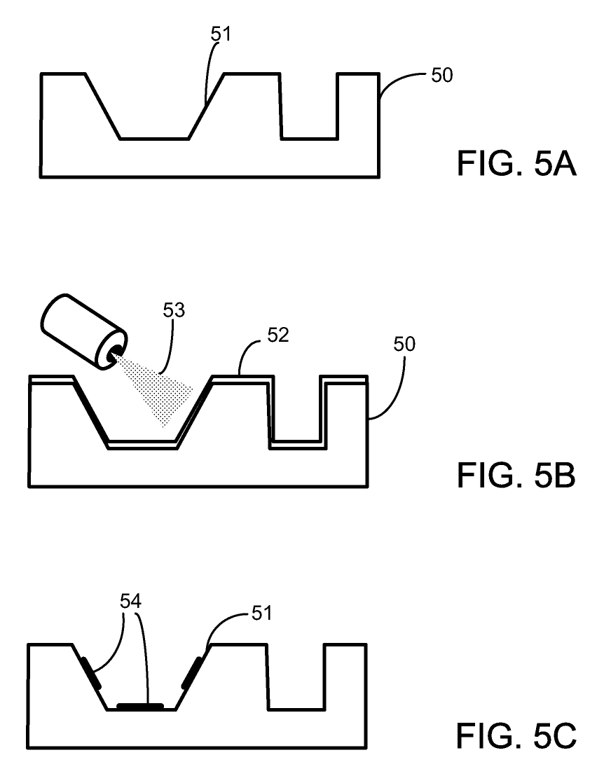

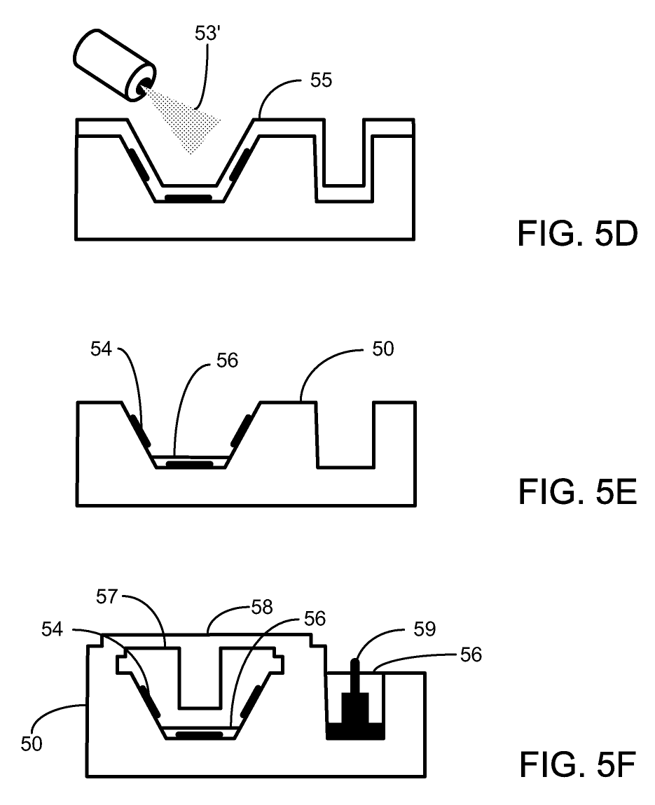

Another limitation of conventional electroplating of magnets is the difficulty in achieving many of the complex geometries necessary to create certain mechanical components. Many of the sensing or actuation applications have high topography magnetic micro component or structures. Magnetically loaded polymer films (i.e., magnet/polymer films) can be conformally resist-coated onto these high topographies. However, newly developed methods for conformal resist coating can be applied to magnetically loaded polymer films. Two such methods include conformal spray coating and solvent-rich spin coating. In these cases, the ability to coat a thick polymer coating conformally is enabled by atomizing solvent-rich resist during a spray coating or creating a solvent-rich spin-coating environment, respectively. One exemplary conformal coating method is illustrated in FIGS. 5A-5F (spray coating).

By combining conformal coating with multi-level processing and photoimaging, unique 3-dimensional micro structures can be created. Referring to FIG. 5A, a substrate 50 with a high topography surface 51 is illustrated. By the term “high topography”, what is intended is a feature having a height (depth) that is significantly greater than the thickness of the film being coated. For example, a 100 micrometer (μm) deep cavity is “high topography” for a 5 μm coating; as another example, a 50 μm deep cavity is “high topography” for a 3 μm coating. In FIG. 5B, a conformal resist coating 52 is applied over substrate 50; in this embodiment, conformal resist coating 52 is applied via spraying an atomized magnet/polymer material 53. Conformal resist coating 52 is patterned in FIG. 5C to provide active magnetic material 54 on topography 51. A second conformal resist coating 55 is applied over substrate 50 and previously formed active magnetic material 54 in FIG. 5D via spraying an atomized magnet/polymer material 53′. Magnet/polymer material 53′ may be the same as or different than magnet/polymer material 53. Magnet/polymer resist coating 55 is patterned in FIG. 5E to provide active magnetic material 56 on topography 51 and optionally on active magnetic material 54. Additional processing can be done to form additional structures, either magnetic or non-magnetic. For example, FIG. 5F illustrates a structure that has substrate 50 having a first region with active magnetic material 54, 56 therein covered with a filler material 57 (e.g., a sacrificial material) and having a covering layer 58. Substrate 50 also includes a second region having magnetic material 56 and a discrete magnetic or non-magnetic structure 59 therein. Filler material 57 and structure 59 may be formed by repeated coating, exposing and patterning to obtain the desired geometries.

The methods shown in FIGS. 5A-5F could be utilized to create complex, high-topography electromagnetic structures, such as a microfabricated electromagnetic rotary motor.

Solvent-rich spin coating is another method of combining conformal coating with multi-level processing to create unique 3-dimensional structures. For example, a spin-coating method could be used to apply a conformal solvent-rich magnetic coating onto a substrate that has a high-topography surface. In certain spin-coating methods, a volume of solvent-rich magnet/polymer material is placed on the substrate. High speed rotation of the substrate distributes the magnet/polymer material evenly across substrate and its topography. In some embodiments, a spin-coating apparatus includes a table for supporting and spinning the substrate within a covered enclosure that contains the solvent vapors. Such a covered apparatus produces a higher quality conformal coating than uncovered spin-coating apparatuses.

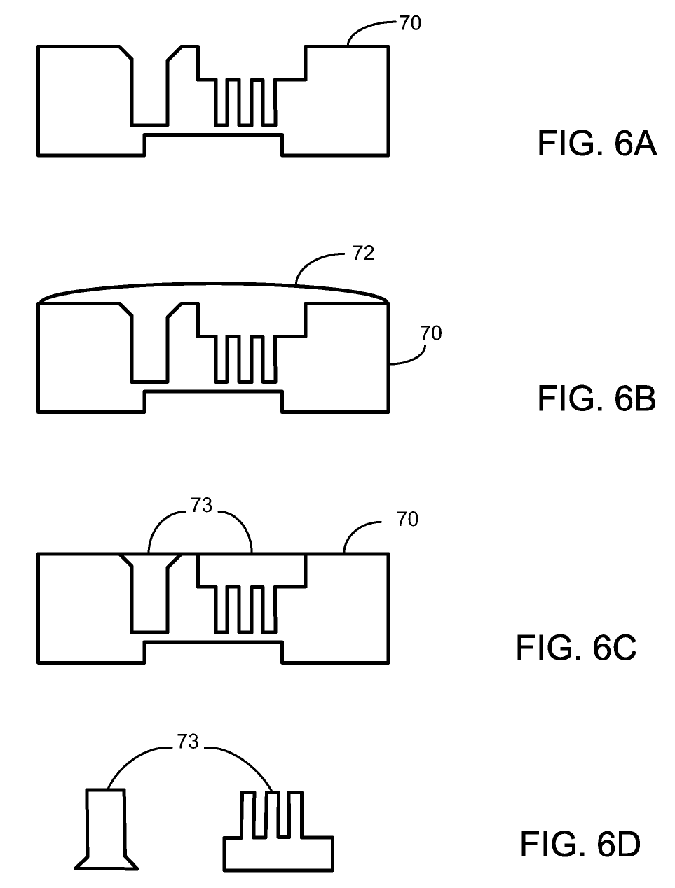

As another variation, complex 3-dimensional magnetic structures can be formed using damascene printing of previously formed complex geometry molds. A complex geometry mold (e.g., having deep-trench etched topography with high aspect ratio structures) may be filled (e.g., backfilled) with a magnet/polymer material. Referring to FIGS. 6A-6D, a complex mold 70 is illustrated in FIG. 6A. Mold 70 may be fabricated by other complex geometry fabrication methods, such as deep trench silicon etching, high-aspect ratio photoresist patterning, deep oxide/insulator etching, wafer bonding, isotropic wet and dry etching, and other microfabrication methods. In FIG. 6B, magnet/polymer material 72 is applied to mold 70 to fill all topography. Any extraneous material 72 can be removed (e.g., “squeegeed”) prior to polishing, lapping, or planarization of the structure. FIG. 6C illustrates mold 70 with two complex magnetic structures 73 therein. In FIG. 6D, structures 73 have been removed from mold 70.

The complex 3-dimensional magnetic structures, formed by any of the methods described herein, may be incorporated into MEMS systems. The complex 3-dimensional magnetic structures are particularly suited for self-assembly in MEMS in which a series of microelectromechanical elements (e.g., mirrors, circuits, sensors, etc.) are autonomously assembled into precise locations of a larger system, often using fluid mediums for transport and reference mechanisms for positioning. Alternately, polymer magnets formed by any of the methods described herein, may be incorporated into previously formed structures and then assembled into MEMS systems via self-assembly.

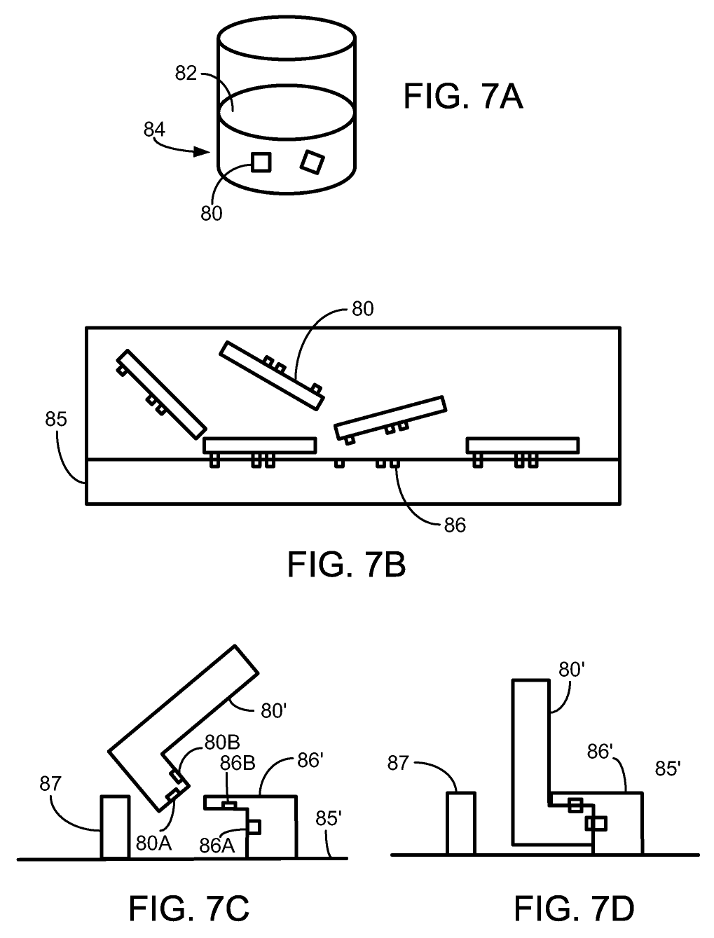

Self-assembly methods of MEMS and micro components are illustrated in FIGS. 7A-7D. In FIG. 7A, complex 3-dimensional magnetic structures 80 (in some embodiments about 100 μm to several hundred micrometers in size) are present in a volume of fluid 82 (e.g., liquid) forming a pourable mixture 84. Structures 80 may be suspended in fluid 82 or may settle. At least a portion of structure 80 is magnetic (the magnetic regions, in some embodiments, being about 10 μm to several tens of micrometers in size). In FIG. 7B, mixture 84 is applied onto a substrate 85 having patterned thereon receptor sites 86 configured for engagement with structures 80. Structures 80 settle on substrate 85 and engage with receptor sites 86. The preferential orientation for structures 80 to “self-assemble” to receptor sites 86 can include, but is not limited to, mechanical slots, surface attraction forces, electric fields, or electromagnetic fields. Additional excitation (e.g., ultrasonic vibration, stirring, etc.) may be needed for effective transport and positioning of the components.

More complex engagement of magnetic structures with receptor sites is illustrated in FIGS. 7C and 7D. In these figures, complex 3-dimensional structure 80′ has magnetic regions 80A, 80B. Substrate 85′ has receptor structure 86′ with corresponding magnetic regions 86A, 86B and also includes an annex structure 87. Annex structure 76 may be any structure that might hinder direct insertion or coupling of complex 3-directional structure 80′ to the desired receptor structure 86′. In the illustrated embodiment of FIGS. 7C and 7D, annex structure 87 is positioned and shaped in a manner that inhibits direct lateral insertion of 3-dimensional structure 80′ into receptor structure 86′, but rather, 3-dimensional structure 80′ engages best if directed at an angle to receptor structure 86′. Receptor structure 86′ and annex structure 87 are designed to mechanically guide structure 80′ into engagement with receptor structure 86′. These structures 86′, 87 may be configured in a manner to limit the possible orientation of 3-dimensional structure 80′. The interaction between magnetic regions 80A, 80B and 86A, 86B in this embodiment, is sufficient to orient structure 80′ into receptor structure 86′. In some embodiments, however, adding magnetic materials with a desired magnetic property is not always compatible or sufficient to orientate a complex 3-dimensional geometry. External or integrated electromagnetic fields could also be implemented locally or globally to facilitate orientation of the components during.

The discussion above has described numerous embodiments directed to micro scale 3-dimensional magnetic structures and various methods of making them. In many embodiments, these magnetic micro structures are from about 10 micrometers (μm) in size to several hundred micrometers in size, in some embodiments from about 10 μm to 100 μm. For example, disclosed have been methods that utilize magnetic particles or powder added to photoimageable polymers (e.g., photoresist) to allow precise lithographic patterning of a desired geometry. By use of multiple coatings and exposures, a complex 3-dimensional polymer magnetic micro structure can be created. In some embodiments, complex 3-dimensional magnetic microstructures may have dimensions from about 10 μm to 100 μm. Additionally or alternatively, by use of any or all of multiple coatings, exposures, and materials, a complex, inhomogeneous 3-dimensional micro structure can be created to give preferred electromagnetic performance or planarized geometry. This could include varying magnetic characteristics (e.g. soft magnet, hard magnet), non-magnetic films, or structural films. Also disclosed is the use of conformal coating methods, such as spray coating or solvent-rich spin coating, to conformally coat polymer magnet films over high-topography structures. The conformal polymer magnetic coating can be combined with the other methods such as multilevel coating and exposing, hybrid combination with different materials or magnetic characteristics, or combined with structural elements, to create a desired micromechanical electromagnetic structure. The topographical structures can be formed by microfabrication methods such as silicon deep reactive ion etching, metal electroplating, inductively coupled plasma (ICP) insulator etching, multilevel photoresist, wet/dry isotropic etching, or wafer bonding. A damascene patterning method can be used to backfill the topography with magnetic material and then planarize the material. For example, a squeegee or spin coating method could be used to apply the magnetic material.

Polymeric magnets (e.g., formed by coating of magnet/polymer films) and other 3-dimensional magnetic structures provide the ability to create unique structures that have receptor alignment sites for microscale self-assembly. Either or both the receptor structure and the magnetic structure could be formed with complex 3-dimensional structures with a designed engagement orientation to facilitate engagement of the two structures. The patternability available with polymeric magnets allow for highly flexible implementation of this concept into many applications.

Thus, embodiments of the THREE-DIMENSIONAL MAGNETIC STRUCTURES FOR MICROASSEMBLY are disclosed. The implementations described above and other implementations are within the scope of the following claims. One skilled in the art will appreciate that the present disclosure can be practiced with embodiments other than those disclosed. The disclosed embodiments are presented for purposes of illustration and not limitation, and the present invention is limited only by the claims that follow.

The use of numerical identifiers, such as “first”, “second”, etc. in the claims that follow is for purposes of identification and providing antecedent basis. Unless content clearly dictates otherwise, it should not be implied that a numerical identifier refers to the number of such elements required to be present in a structure, system or apparatus. For example, if a structure includes a first component, it should not be implied that a second component is required in that structure.

What is claimed is:

1 A micro structure self assembly method comprising:
providing a substrate having at least one magnetic receptor site; and
engaging a 3-dimensional magnetic micro structure having a first magnetic/polymer micro component with the substrate by aligning the magnetic micro component with the magnetic receptor site.

2. The method of claim 1 wherein the first magnetic/polymer component comprises magnetic particles in photoimageable polymer.

3. The method of claim 1 wherein the 3-dimensional magnetic micro structure further comprises a second magnetic/polymer component different than the first magnet/polymer component.

4. The method of claim 1 wherein the 3-dimensional magnetic micro structure comprises a conformal magnetic coating.

5. The method of claim 1 wherein the substrate comprises a plurality of magnetic receptor sites and the 3-dimensional magnetic micro structure comprises a plurality of magnetic micro components, wherein each magnetic micro component is aligned with a magnetic receptor site.

6. The method of claim 1 wherein the step of aligning comprises utilizing an electromagnetic field.

7. The method of claim 6 wherein the step of utilizing an electromagnetic field comprises utilizing an external magnetic field or an integrated magnetic field.

8. The method of claim 1 wherein the step of aligning comprises utilizing a mechanical assembly guide.

9. A method of self assembly of micro structures comprising:
providing a substrate having at least one magnetic receptor site;
providing a mixture of 3-dimensional magnetic micro structures, each 3-dimensional magnetic micro structure comprising:
a base substrate; and
at least one magnetic micro component on the base substrate, the magnetic micro component comprising magnetic particles and polymer;
engaging the 3-dimensional magnetic micro structure with the substrate by aligning the magnetic micro component with the magnetic receptor site.

10. The method of claim 9 wherein providing a mixture of 3-dimensional magnetic micro structures comprises:
providing a mixture of 3-dimensional magnetic micro structures comprising heterogeneous magnetic micro components.

11. The method of claim 10 wherein the heterogeneous magnetic micro components comprise at least two of soft magnets, hard magnets, non-magnetic films, or structural films.

12. The method of claim 9 wherein providing a mixture of 3-dimensional magnetic micro structures comprises:
providing a mixture of 3-dimensional magnetic micro structures comprising homogeneous magnetic micro components.

13. The method of claim 9 wherein providing a mixture of 3-dimensional magnetic micro structures comprises:
providing a mixture of 3-dimensional magnetic micro structures comprising first magnetic micro components and second magnetic micro components, wherein the first magnetic micro components are different than the second magnetic micro components.

14. The method of claim 9 wherein the 3-dimensional magnetic micro structures comprise magnetic micro components with a conformal magnetic coating.

15. The method of claim 14 wherein the conformal magnetic coating is a sprayed conformal magnetic coating.

16. A method of making a 3-dimensional magnetic micro structure comprising:
providing a substrate;
depositing a first photoimageable magnet/polymer material on the substrate;
patterning the first photoimageable magnet/polymer material to form at least one first active magnetic area and at least one first sacrificial area;
depositing a second photoimageable magnet/polymer material on the at least one first active magnetic area and at least one first sacrificial area;
patterning the second photoimageable magnet/polymer material to form at least one second active magnetic area and at least one second sacrificial area; and
removing the first sacrificial area and the second sacrificial area.

17. The method of claim 16 further comprising:
depositing a third photoimageable magnet/polymer material on the at least one second active magnetic area and at least one second sacrificial area;
patterning the third photoimageable magnet/polymer material to form at least one third active magnetic area and at least one third sacrificial area; and
removing the third sacrificial area.

18. The method of claim 17 wherein the step of removing the first sacrificial area and the second sacrificial area and the step of removing the third sacrificial area are done in a single step.

19. The method of claim 16 wherein the first photoimageable magnet/polymer material and the second photoimageable magnet/polymer material are different materials.

20. The method of claim 16 further comprising, after removing the first sacrificial area and the second sacrificial area:
applying a conformal magnetic coating over the first active magnetic area and the second active magnetic area.
